(19) United States
(12) Patent Application Publication
(10) Pub. No.: US 2013/0255479 A1
(43) Pub. Date: Oct. 3, 2013

(54) Compressed air single-action actuator

(71) Applicants: Chunxiu Liu, Jinan (CN); Yanke Guan, Jinan (CN); Guihua Li, Jinan (CN); Baolin Tian, Jinan (CN)

(72) Inventors: Chunxiu Liu, Jinan (CN); Yanke Guan, Jinan (CN); Guihua Li, Jinan (CN); Baolin Tian, Jinan (CN)

(21) Appl. No.: 13/878,546

(22) PCT Filed: May 19, 2011
(86) PCT No.: PCT/CN2011/000873

§ 371 Date: Apr. 9, 2013

(30) Foreign Application Priority Data
Dec. 22, 2010 (CN) 201020673683.4

(51) Int. Cl. F15B 15/08; F15B 13/02

(52) U.S. Cl. CPC F15B 15/084; F15B 13/02
USPC 91/346; 60/581; 91/536

(57) ABSTRACT

A compressed air single-action actuator includes an actuator body, a solenoid valve is provided in the actuator body, a solenoid valve plate is provided between the actuator body and the solenoid valve, a gas chamber is provided on the side face of the actuator body, an O-ring seal is provided between the gas chamber and the actuator body; a first inlet passage communicated with the gas chamber is provided on the actuator body, a check valve is provided at one end of the gas chamber of the first gas inlet passage, the other end of the outlet is provided at a right back side of the Namur interface; a second gas inlet passage is provided on the actuator body communicated with the gas chamber, the outlet of the second gas inlet passage is provided at an upper left side of the Namur interface.

### CROSS REFERENCE OF RELATED APPLICATION

This is a U.S. National Stage under 35 U.S.C 371 of the International Application PCT/CN2011/000873, filed May 19, 2011, which claims priority under 35 U.S.C. 119(a-d) to CN 201020673683.4, filed Dec. 22, 2010.

### BACKGROUND OF THE PRESENT INVENTION

1. Field of Invention

The present invention relates to a single-action actuator, and more particularly to a compressed air single-action actuator.

2. Description of Related Arts

With the realization of industrial automated production, in the field of flow control, automatic control valves are used widely, specifically in the field of petrochemical industry and food pharmaceutical industry, to improve efficiency, the pipeline is controlled automatically by remote, the valve of the pneumatic actuator which automatically controls switching 90° or 180°, are more and more widely used in fluid pipe and equipment device.

Referring to FIG. 1, a conventional single acting tooth row type pneumatic actuator comprises an actuator body 113, two integrated pistons 102, a rack 103 and a central axle 104. An internal cavity inlet 112, an internal cavity 106 of the actuator body 113 are provided in a center of the actuator body 113. An external cavity main inlet and outlet 110 is communicated with an external cavity 109 through an external cavity inlet and outlet hole 108, wherein the actuator body 113 comprises two pistons 102, which are respectively integrated with the racks 103, wherein an O-ring seal 101 is embedded in a peripheral circle of the piston 102 and divides the actuator body into the internal cavity 106 and the external cavity 109. High-pressure gas enters the internal cavity 106 through the internal cavity inlet 112, the pistons 102 move to two sides respectively under an action of the high-pressure gas, air on the two sides is discharged through the external cavity inlet and outlet hole 108, the pistons 102 push the racks 103 to compress a plurality of reset springs 107 to the two sides, the racks 103 push the central axle 104 to move anticlockwise, so as to drive a central axle for opening the valve. When power and gas is cut, the gas from the internal cavity inlet 112 is cut, the actuator body 113 pushes the pistons 102 from the two sides to a middle under an action of the reset springs 107, the pistons 102 promote the racks 103 and push the central axle 104 to move clockwise, so as to drive the central axle for closing the valve.

The shortcomings of the single-action actuator comprise:

1, when changing the original state (such as opening the valve), the compressed gas not only has to overcome the load brought by action but also has to overcome the resilience and torsion of the spring, which greatly reduces the effective torsion outputted by the single-action actuator. The torsion outputted by a double-action actuator of the same model without the springs under a certain pressure is M1, the torsion outputted by the corresponding single-action actuator with the springs returning to the original state is M2, the torsion outputted at the end of the positive effect which changes the original state under the effect of the compressed gas is M3, and then, M3<M1−M2, the difference is the increased torsion of the springs being compressed (or twisted) from an original state to a final state, whether it is a positive action or a negative action of the spring reset reaction, the load which should be overcame is the same, therefore the M2 and the M3 are required to be as close as possible in the actual production, thus the torsions that the M2 and the M3 outputted by the single-action actuator are less than a half value of the M1, the closer to the half value, the larger the size of the spring is required, because of the size limit of the spring in the actual production, the M2 and the M3 are generally to be about 30% of the M1, and thus the actual efficacy thereof is reduced greatly.

2, the torque is the maximum at the open or the closed stage, when gas and power is cut, the conventional single-action actuator closes the valve only by the elasticity of the spring. When the valve is closed, the stretching of the spring is the maximum, like a spent force, in the stage the outputted force is the smallest, and the torsion for closing the valve is the smallest. It is likely to have the situation that the valve is not closed fully.

3, the single-action actuator gets large torque through using a plurality of springs, there will be the situation of falling and fracture of the springs, when it happens, the actuator will not take the effect of switching valve, even using an external force, the valve also will not be operated for being stuck by the falling spring. The failure is more dangerous in the specific industries.

4, the elastic force of the rack and the gear actuator spring is always in function, when the factory air pressure drops normally, the spring actuator moves left and right with the gas supply changes, the valve may not rotate according to the normal order.

### SUMMARY OF THE PRESENT INVENTION

An object of the present invention is to provide a compressed air single-action actuator to solve the problem that the valve does not close completely, the valve rotates, the valve loses function and the high energy consumption.

A compressed gas single-acting actuator, comprises an actuator body, wherein pistons are respectively provided on left and right ends of the actuator body, a rack is provided on each of the pistons, a central axle is provided between the two racks, a plurality of reset springs (unilateral: 2-7, bilateral: 4-14) are provided between the pistons and the actuator body, an internal cavity is formed between the pistons, an external cavity is formed between the pistons and the actuator body, an external cavity gas chamber path communicated with the external cavity is provided on the actuator body, wherein a solenoid valve is provided on a Namur interface of the actuator body, a solenoid valve plate is provided between the Namur interface and the solenoid valve, a gas chamber is provided on the actuator body, a ring seal is provided between the gas chamber and the actuator body; a first gas inlet passage communicated with the gas chamber is provided on the actuator body, a check valve is provided at a first end of the gas chamber of the first gas inlet passage, and a second end of the outlet is provided at a right back side of the Namur interface for corresponding to a second gas port of the solenoid valve plate; a second gas inlet passage is provided on the actuator body communicated with the gas chamber, an outlet of the second gas inlet passage is provided at an upper left side of the Namur interface for corresponding to a third gas inlet of the solenoid valve plate; a first inlet hole and a second inlet hole are provided in a middle section of a first surface of a solenoid valve joint board side by side, a first groove is provided in the first inlet hole, a second groove is provided in the second inlet hole; a first gas port is provided below the first inlet hole, a second gas port is provided below the second inlet hole, a fourth gas port and a fifth gas port are respectively provided on both sides of the first gas port, a third gas port is provided at un upper left of the first inlet hole; a first channel is provided between the first gas port and the second gas port, a second channel is provided between the third gas port and the fourth gas port and between the fourth gas port and the fifth gas port; the third gas port and the second gas port are through-holes; a rubber pad is provided on a first surface of the solenoid valve plate, a groove corresponding with the first surface, and a through hole communicated with the first groove, the second groove, the first gas port, the fourth gas port, and the fifth gas port are provided on the rubber pad, a first surface of a solenoid valve joint board is corresponded with a bottom of the solenoid valve; a separator is provided in a through hole on a bottom of the solenoid valve, which corresponds with the first gas port, the fourth gas port and the fifth gas port of the solenoid valve joint board, the separator divides the through hole into three chambers; a first chamber and a third chamber are blind holes, communicated with the fourth gas port and the fifth gas port respectively, the second chamber is a through hole communicated with the first gas port; a proportion of a gas volume of the gas chamber and a gas volume of the actuator body is not less than 0.5:1.

Preferably, an additional reset spring is provided between the pistons and a side cover of the actuator body, and the actuator, the additional reset spring and the piston are coaxial.

Preferably, no spring is provided between the pistons and the side cover of the actuator body, and the actuator body.

Preferably, more than one gas chamber is provided outside the actuator body.

The beneficial effect: two additional gas paths are provided in a conventional actuator body to communicate with additional unilateral or bilateral gas chamber, the compressed gas in the gas chamber is used to ensure that the valve is closed without power or without gas.

### BRIEF DESCRIPTION OF THE DRAWINGS

Specific characteristics and properties of the present invention are further illustrated by preferred embodiments and drawings according to the preferred embodiments as follows.

FIG. 1 is a sectional view of a conventional tooth row pneumatic actuator according to a preferred embodiment of the present invention.

FIG. 2 is a sectional view of a single gas chamber actuator with springs according to a preferred embodiment of the present invention.

FIG. 3 is a sectional view of a double gas chamber actuator without springs according to a preferred embodiment of the present invention.

FIG. 4 is a top view of a solenoid valve plate without a rubber pad according to a preferred embodiment of the present invention.

FIG. 5 is a top view of a solenoid valve plate with a rubber pad according to a preferred embodiment of the present invention.

FIG. 6 is a bottom view of a bottom plane of a solenoid valve according to a preferred embodiment of the present invention.

FIG. 7 is a sketch view of an actuator internal gas path according to a preferred embodiment of the present invention.

FIG. 8 is an action diagram of the actuator with power and gas according to a preferred embodiment of the present invention.

FIG. 9 is an action diagram of the actuator without power and gas according to a preferred embodiment of the present invention.

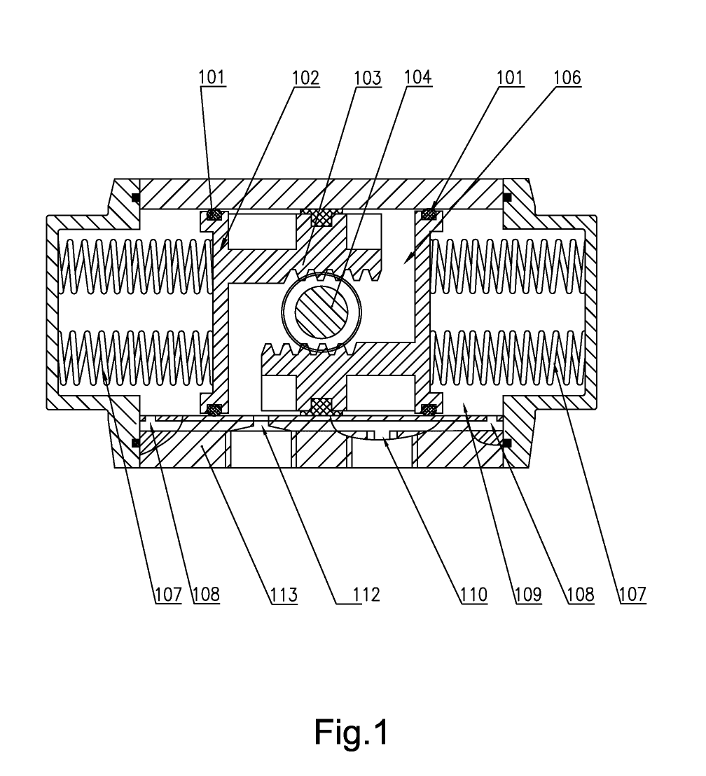

101 O-ring seal, 102 piston, 103 rack, 104 central axle, 106 internal cavity, 107 reset spring, 108 external cavity inlet and outlet hole, 109 external cavity, 110 external cavity main inlet and outlet, 111 O-ring seal, 112 internal cavity inlet, 113 actuator body, 114 side cover of actuator body, 12 gas chamber, 121 left gas chamber, 122 right gas chamber, 201 solenoid valve, 202 solenoid valve plate, 203 first surface, 204 first inlet hole, 205 second inlet hole, 206 first groove, 207 second groove, 208 first gas port, 209 second gas port, 210 third gas port, 211 fourth gas port, 212 fifth gas port, 213 first channel, 214 second channel, 215 rubber pad, 216 separator, 217 first chamber, 218 second chamber, 219 third chamber, 301 external cavity air chamber path, 302 first inlet passage, 303 second inlet passage, 304 check valve

### DETAILED DESCRIPTION OF THE PREFERRED EMBODIMENT

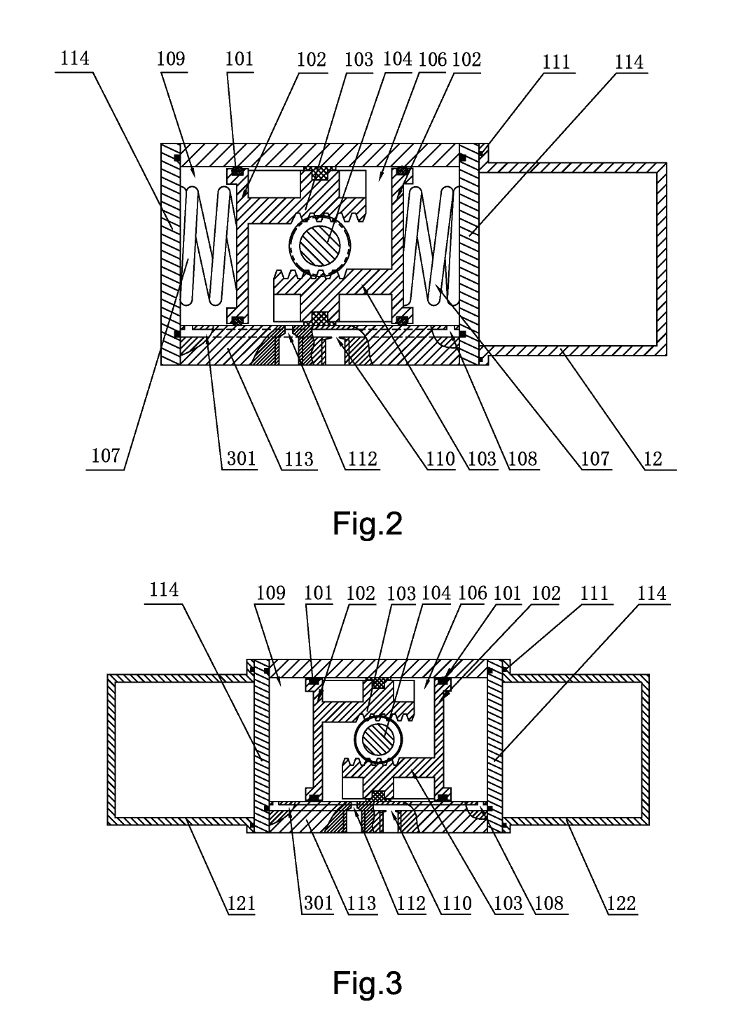

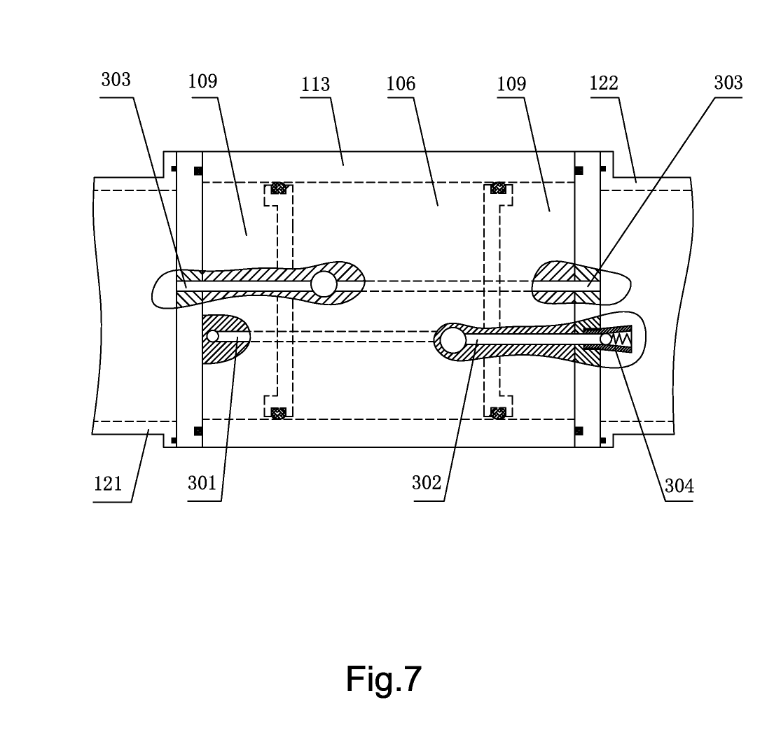

Referring to FIG. 2, a compressed air single-action actuator, comprises an actuator body 113, pistons 102 respectively provided at two ends of the actuator body 113, racks 103 respectively provided on the pistons 102, and a central axle 104 provided between the racks 103. a plurality of of reset springs 107 provided between the pistons 102 and the corresponding actuator body 113, an internal cavity 106 defined between the pistons 102, an external cavity 109 defined between the pistons 102 and the actuator body 113, an external cavity air chamber path 301 communicated with the external cavity 109 provided on the actuator body 113, a solenoid valve 201 coupled on a Namur interface of the actuator body 113, a solenoid valve plate 202 provided between the Namur interface and the solenoid valve 201, a gas chamber 12 provided on the actuator body 113, an O-ring seal 111 provided between the gas chamber 12 and the actuator body 113; Referring to FIG. 7, a first inlet passage 302 communicated with the gas chamber 12 (122) is provided on the actuator body 113, a check valve 304 is provided at a first end of the first gas inlet passage 302 on the gas chamber 12 (122), a second end of the first gas inlet passage 302 is provided at a right back side of the Namur interface for corresponding to a second gas port 209 of the solenoid valve plate 202; a second gas inlet channel 303 is provided on the actuator body 113 communicated with the gas chamber 12 (121 and 122), an outlet of the second gas inlet channel 303 is provided at an upper left side of the Namur interface for corresponding to a third gas inlet 210 of the solenoid valve plate 202; a proportion of a gas storage volume of the gas chamber 12 and an effective volume of the actuator body 113 optimally is more than 2:1, thus a pressure is always above 5 bar, a minimum torque is more than 60% of the torque outputted by a double-action actuator, so as to ensure that the valve is in a safe state when lacking of gas and power.

Preferably, referring to FIG. 2, no spring is provided between the pistons 102 and a side cover of the actuator body 114, and the actuator body 113.

Preferably, referring to FIG. 3, an additional reset spring is provided between the pistons 102 and the side cover of the actuator body 114, and the actuator 113, the additional reset spring and the piston 102 are coaxial.

Preferably, referring to FIG. 3, two gas chambers, i.e., a left gas chamber 121 and a right gas chamber 122 are respectively provided outside the external cavity 109.

Preferably, referring to FIG. 2, a gas chamber 12 is provided on one side of the actuator body 113, and mounted on a left or right outside the external cavity 109.

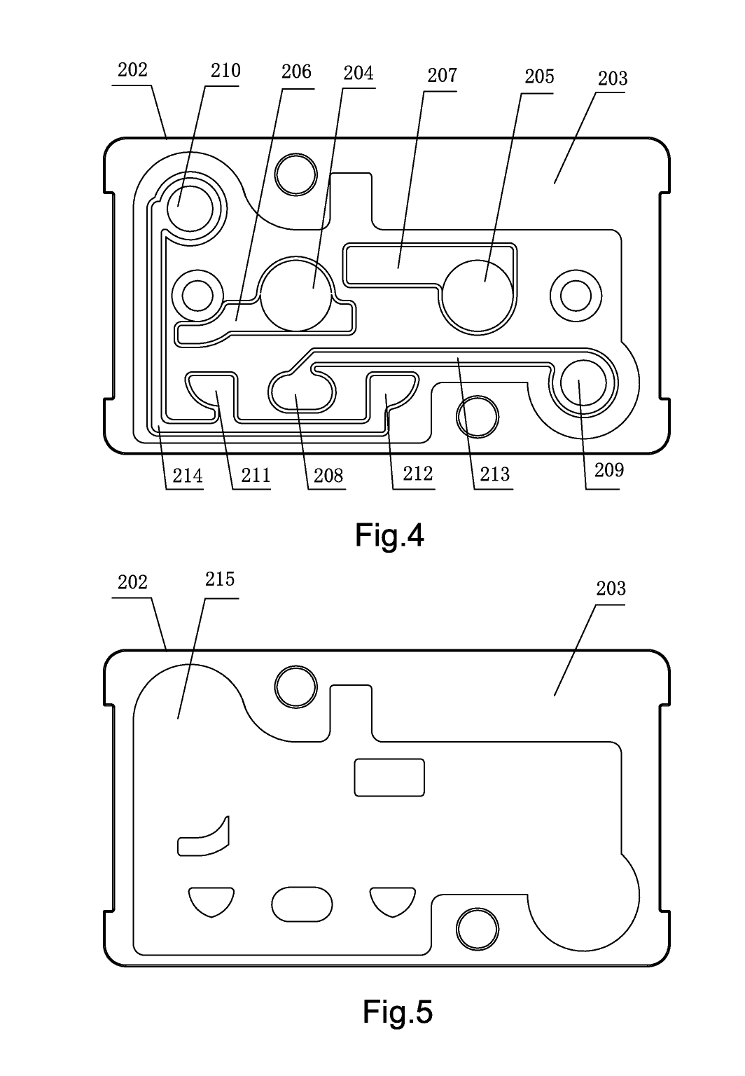

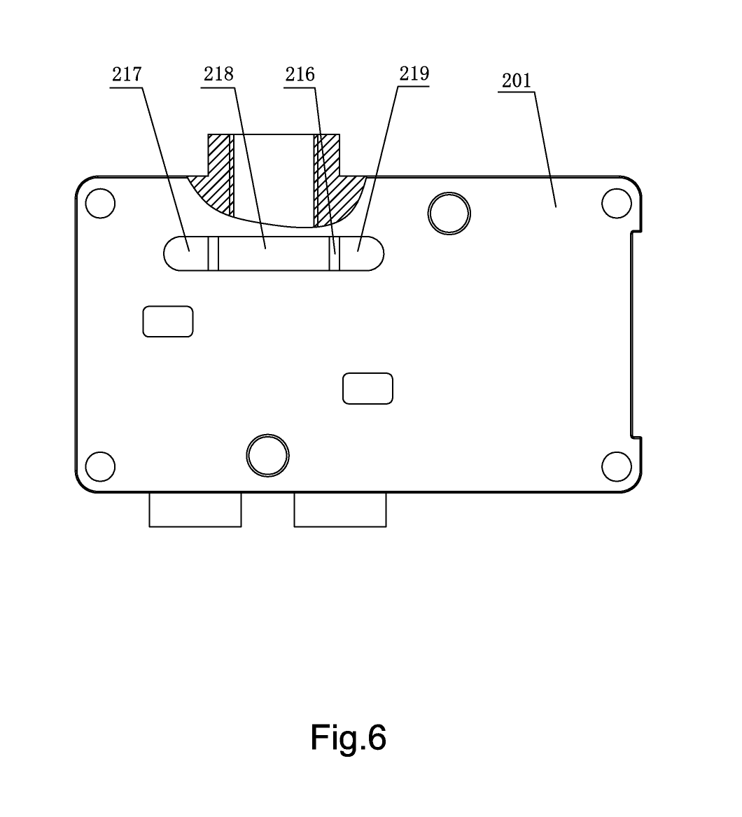

Referring to FIG. 4, a first inlet hole 204 and a second inlet hole 205 are provided in a middle section of a first surface 203 of a solenoid valve joint board 202 side by side, a first groove 206 is provided in the first inlet hole 204, a second groove 207 is provided in the second inlet hole 205; a first gas port 208 is provided below the first inlet hole 204, a second gas port 209 is provided below the second inlet hole 205, a fourth gas port 211 and a fifth gas port 212 are respectively provided on both sides of the first gas port 208, a third gas port 210 is provided at the upper left of the first inlet hole 204; a first channel 213 is provided between the first gas port 208 and the second gas port 209, a second channel 214 is provided between the third gas port 210 and the fourth gas port 211 and between the fourth gas port 211 and the fifth gas port 212; the third gas port 210 and the second gas port 209 are through-holes; Referring to FIG. 5, a rubber pad 215 is provided on a first surface 203 of the solenoid valve plate 202, a groove corresponding with the first surface 203, and a through hole communicated with the first groove 206, the second groove 207, the first gas port 208, the fourth gas port 211 and the fifth gas port 212 are provided on the rubber pad 215; a first surface 203 of a solenoid valve joint board 202 is corresponded with a bottom of the solenoid valve 201; Referring to FIG. 6, a separator 216 is provided in a through hole on a bottom of the solenoid valve 201, which corresponds with the first gas port 208, the fourth gas port 211 and the fifth gas port 212 of the solenoid valve joint board 202, the separator 216 divides the through hole into three chambers; a first chamber 217 and a third chamber 219 are blind holes, communicated with the fourth gas port 211 and the fifth gas port 212 respectively, the second chamber 218 is a through hole communicated with the first gas port 208.

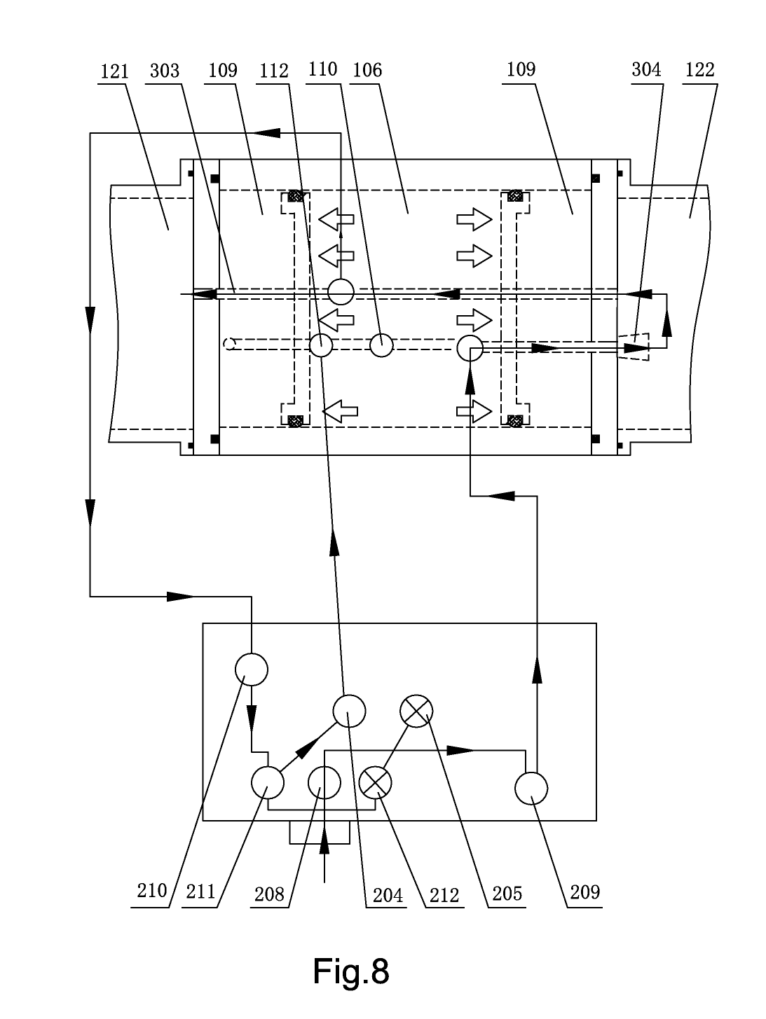

Referring to FIG. 8, with power and gas, the gas enters the solenoid valve 201, wherein the gas enters the right gas storage chamber 122 from the first gas port 208, in turn through the the first channel 213, the second gas port 209, the first inlet passage 302 of the actuator body 113. The compressed gas in the right gas storage chamber 122 enters the left gas storage chamber 121 through the second inlet passage 303 of the actuator body 113, and through the third air gas port 210 back to the fourth gas port 211 and the fifth gas port 212 of the solenoid valve plate 202. Under an effect of an electromagnetic coil and the outside air of the solenoid valve 201, the fifth gas port 212 of the solenoid valve plate 202 which is communicated with the second inlet hole 205 is blocked, the fourth gas port 211 communicated with the first air gas port 204 is opened, thus the compressed gas flowing back to the solenoid valve 201 from the left gas chamber 121 and the right gas chamber 122 enters the internal cavity 106 of the actuator body 113, the pistons move to both sides and drive the racks 103 to move to both sides under the high pressure gas, the racks 103 drive the central axle 104 to rotate counterclockwise, so as to drive the central axle to open the valve.

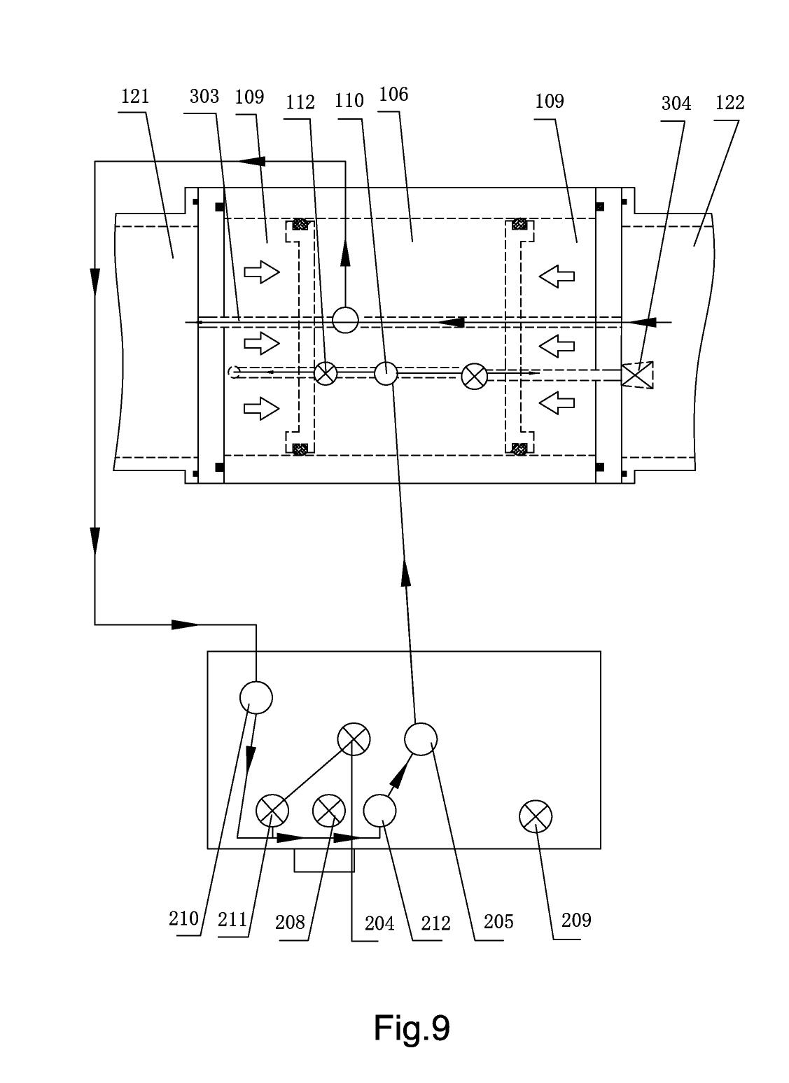

Referring to FIG. 9, single action without power and gas (failure state 1): No outside compressed gas enters, the internal check valve 304 provided behind the first inlet passage 302 closes, so as to prevent the compressed air pressure flowing from the right gas storage chamber 122 to the first gas port 208 of the solenoid valve joint board 202. The compressed gas in the left gas storage chamber 121 and the right gas storage chamber 122 flows back to the fourth gas port 211 and the fifth gas port 212 of the solenoid valve plate 202 through the third air gas port 210 communicated with the second inlet passage 303. Without power and gas for the solenoid valve 201, the fourth gas port 211 communicated with the first gas port 204 is blocked and the fifth gas port 212 communicated with the second gas port 205 is opened under the effect of the elasticity of the spring. Thus the compressed gas flowing back to the solenoid valve 201 from the left gas chamber 121 and the right gas chamber 122 enters the external cavity 109 in turn through the second gas port 205 and the external cavity air chamber path 301 provided in the actuator body 113, the pistons move to the middle and drive the racks 103 to move to the middle under the high pressure gas in the external cavity 109, the racks 103 drive the central axle 104 to rotate clockwise, so as to drive the central axle to close the valve.

Referring to FIG. 9, single action with power and without gas (failure state 2): No outside compressed gas enters, the internal check valve 304 provided behind the first inlet passage 302 closes, so as to prevent the compressed air pressure flowing from the right gas storage chamber 122 to the first gas port 208 of the solenoid valve joint board 202. The compressed gas in the left gas storage chamber 121 and the right gas storage chamber 122 flows back to the fourth gas port 211 and the fifth gas port 212 of the solenoid valve plate 202 through the third air gas port 210 communicated with the second inlet passage 303. The movable rail of the solenoid valve 201 opens under the effect of electromagnetic coil, but no outside gas enters, the fourth gas port 211 communicated with the first gas port 204 is blocked and the fifth gas port 212 communicated with the second gas port 205 is opened by the solenoid valve 201 under the effect of the elasticity of the spring. Thus the compressed gas flowing back to the solenoid valve 201 from the left gas chamber 121 and the right gas chamber 122 enters the external cavity 109 through the second gas port 205, the pistons 102 move to the middle and drive the racks 103 move to the middle under the high pressure gas in the external cavity 109, the rack 103s drive the central axle 104 to rotate clockwise, so as to drive the central axle close the valve.

Referring to FIG. 9, single action without power and with gas (failure state 3): outside compressed gas enters the solenoid valve 201, wherein outside compressed gas enters the first gas port 208 of the solenoid valve plate 202, and enters the second gas port 209 through the first channel 213, the gas in the second gas port 209 flows into the right gas chamber 122 through the first inlet passage 302. The compressed gas in the right storage chamber 122 enters the left storage chamber 121 through the second air inlet passage 303, and flows back to the fourth gas port 211, the fifth gas port 212 of the solenoid valve plate 202 through the third air gas port 210 at the same time. Without power and with gas, the movable rail of the solenoid valve 201 can not be opened even with external air, the fourth gas port 211 communicated with the first gas port 204 is blocked and the fifth gas port 212 communicated with the second gas port 205 is opened by the electromagnetic coil 201 under the effect of the elasticity of the spring. Thus the compressed gas flowing back to the solenoid valve 201 from the left gas chamber 121 and the right gas chamber 122 enters the external cavity 109 through the second gas port 205, the pistons 102 move to the middle and drive the racks 103 move to the middle under the high pressure gas in the external cavity 109, the rack 103s drive the central axle 104 to rotate clockwise, so as to drive the central axle to close the valve.

The check valve 304 let the gas enter the gas chamber 12 only when the gas pressure in the factory is greater than the gas pressure in the gas chamber 12, thus, the gas pressure in the gas chamber 12 is at the highest value of current pressure supplied. When the gas pressure in the factory is greater than the gas pressure in the gas chamber 12, the check valve 304 is opened, the gas enters the gas chamber 12, so that the level of the gas pressure is the highest. When the gas supply pressure in the factory drops in unexpectedly that air supply pressure in the factory is less than or equal to the gas pressure in the chamber 12, the check valve will close and prevent the actuator moving. The problem that the valve of the conventional actuator does not rotate in the order due to the pressure fluctuation when the spring is used to control the valve is solved.

Two additional gas path are provided on the conventional actuator body 113, combined with the gas path setting of the solenoid valve plate 202, an external gas path setting is not necessary, all the gas paths are provided in the inner to improve the use safety.

1. A compressed gas single-acting actuator, comprises an actuator body, wherein pistons are respectively provided on left and right ends of said actuator body, a rack is provided on each of said pistons, a central axle is provided between said two racks, a plurality of reset springs are provided between said pistons and said actuator body, an internal cavity is formed between said pistons, an external cavity is formed between said pistons and said actuator body, an external cavity gas chamber path communicated with said external cavity is provided on said actuator body, wherein a solenoid valve is provided on a Namur interface of said actuator body, a solenoid valve plate is provided between said Namur interface and said solenoid valve, a gas chamber is provided on said actuator body, a ring seal is provided between said gas chamber and said actuator body; a first gas inlet passage communicated with said gas chamber is provided on said actuator body, a check valve is provided at a first end of said gas chamber of said first gas inlet passage, and a second end of said outlet is provided at a right back side of said Namur interface for corresponding to a second gas port of said solenoid valve plate; a second gas inlet passage is provided on said actuator body communicated with said gas chamber, an outlet of said second gas inlet passage is provided at an upper left side of said Namur interface for corresponding to a third gas inlet of said solenoid valve plate.

2. The compressed gas single-acting actuator, as recited in claim 1, wherein an additional reset spring is provided between said piston and a side cover of said actuator body and said actuator body, said additional reset spring and said piston are coaxial.

3. The compressed gas single-acting actuator, as recited in claim 1, wherein no spring is provided between said piston and said side cover of said actuator body and said actuator body.

4. (canceled)

5. The compressed gas single-acting actuator, as recited in claim 1, wherein a proportion of a gas volume of said gas chamber and a gas volume of said actuator body is not less than 0.5:1.

6. The compressed gas single-acting actuator, as recited in claim 1, wherein a first inlet hole and a second inlet hole are provided in a middle section of a first surface of a solenoid valve joint board side by side, a first groove is provided in said first inlet hole, a second groove is provided in said second inlet hole;
a first gas port is provided below said first inlet hole, a second gas port is provided below said second inlet hole, a fourth gas port and a fifth gas port are respectively provided on both sides of said first gas port, a third gas port is provided at un upper left of said first inlet hole; a first channel is provided between said first gas port and said second gas port, a second channel is provided between said third gas port and said fourth gas port and between said fourth gas port and said fifth gas port; said third gas port and said second gas port are through-holes; a rubber pad is provided on a first surface of said solenoid valve plate, a groove corresponding with said first surface, and a through hole communicated with said first groove, said second groove, said first gas port, said fourth gas port, and said fifth gas port are provided on said rubber pad, a first surface of a solenoid valve joint board is corresponded with a bottom of said solenoid valve.

7. The compressed gas single-acting actuator, as recited in claim 1, wherein a separator is provided in a through hole on a bottom of said solenoid valve, which corresponds with said first gas port, said fourth gas port and said fifth gas port of said solenoid valve joint board, said separator divides said through hole into three chambers; a first chamber and a third chamber are blind holes, communicated with said fourth gas port and said fifth gas port respectively, said second chamber is a through hole communicated with said first gas port.

8. The compressed gas single-acting actuator, as recited in claim 1, wherein more than one gas chamber is provided outside said actuator body.

9. The compressed gas single-acting actuator, as recited in claim 2, wherein more than one gas chamber is provided outside said actuator body.

10. The compressed gas single-acting actuator, as recited in claim 3, wherein more than one gas chamber is provided outside said actuator body.
